(19) United States
(12) Patent Application Publication
(10) Pub. No.: US 2011/0015946 A1
(43) Pub. Date: Jan. 20, 2011

(54) INSURANCE DATA COMMUNICATION SYSTEM

(75) Inventors: Derek Buckowsky, Wellesley, MA (US); Louisa Bolick, Arlington, MA (US)

Correspondence Address: CLARK & ELBING LLP, 101 FEDERAL STREET, BOSTON, MA, 02110, US

(73) Assignee: LIVELONG LLC, Arlington, MA (US)

(21) Appl. No.: 12/837,874

(22) Filed: Jul. 16, 2010

Related U.S. Application Data
(60) Provisional application No. 61/226,314, filed on Jul. 17, 2009.

(51) Int. Cl. G06F 19/00; G06Q 50/00

(52) U.S. Cl. 705/3

(57) ABSTRACT

The invention features devices and methods for providing insurance information to an insured or an insured family member's mobile communication device (e.g., a cell phone or personal data assistant.

### CROSS-REFERENCE TO RELATED APPLICATIONS

This application claims the benefit of U.S. Provisional Application Ser. No. 61/226,314, filed Jul. 17, 2009, which is hereby incorporated by reference.

### BACKGROUND OF THE INVENTION

The invention relates to the field of mobile communication devices.

Conventional methods for providing insurance information to the insured or insured family members are generally delivered by mail or, in some instances, by email or web portal. The disadvantages to the conventional methods of insurance information delivery result in inefficient and/or delayed receipt of information, delayed healthcare services, ineffective healthcare delivery, incorrect healthcare member billing or insurance information, and/or non-delivery of information in the event of an incorrect mailing address.

Accordingly, there is a need in the art for an improved, efficient system and method for addressing above, and related, issues.

### SUMMARY OF THE INVENTION

In one aspect, the invention features a mobile communication device, wherein the device stores an individual's insurance information (e.g., individual's insurance account number or identification number assigned by the insurance provider or insured's employer and the name of the individual's insurance provider), wherein the information is viewable on the device, and wherein the information is sufficient to allow a service provider (e.g., a medical service provider) to identify the source and content of the individual's insurance coverage using a service provider computer. The insurance information can be electronically transmissible (e.g., wirelessly) to the service provider computer.

In certain embodiments, the mobile communication can further store medical information (e.g., a reminder to take at least one medication, identification of a generic alternative to a brand name drug, information regarding a mail order pharmacy, a reminder to fill a prescription, the initiation of a medical records transfer, information regarding disease management, information regarding maternity management, information regarding case management, information regarding patient management, information regarding health coaching, information regarding transplant management, and emergency messaging (e.g., how to fill scripts before or after a hurricane or other natural disaster) which is viewable on the mobile communication device.

In another aspect, the invention features a method of providing an individual with insurance information (individual's insurance account number or identification number assigned by the insurance provider or insured's employer and the name of the individual's insurance provider) by transmitting the insurance information to the individual's mobile communication device. This method can further include transmitting medical information (e.g., a reminder to take at least one medication, identification of a generic alternative to a brand name drug, information regarding a mail order pharmacy, a reminder to fill a prescription, information regarding denial or approval of prescription drug authorizations, information regarding a step therapy program, information regarding drug to drug interaction, information regarding drug to disease interactions, information regarding adding a therapy, information regarding stopping a therapy, information regarding wellness reminders, information regarding the initiation of a medical records transfer, information regarding disease management, information regarding maternity management, information regarding case management, information regarding patient management, information regarding health coaching, information regarding transplant management, and emergency messaging).

In either of the foregoing aspects, the insurance can be, e.g., medical insurance, dental insurance, vision insurance, or life insurance. The insurance information can further optionally include at least one of the following: the insurance provider's logo, the individual's network name, the individual's network logo, the individual's employer's name, the individual's employer's logo, the individual's group identification number, the insurance provider's telephone number, the individual's name, the individual's copayment, the individual's deductable, and the insurance provider's web address.

The foregoing transmission of insurance and/or medical information can be by, e.g., email, Application 2 Mobile—Short Messaging Service (SMS) text message, or through the world wide web. The medical information can also be imported into the calendar program of the mobile communication device.

By “mobile communication device” is meant any portable device that, while active, continuously connects to a communication or data network. The term “mobile communication device” is meant to include cell phones, personal data assistants, so called “smart phones,” and iphones®. Mobile communication devices include, e.g., devices that are less than 1 lb, 0.5 lbs, 0.25 lbs or less. The term “mobile communication device” is not meant to include personal computers, including laptop computers.

By “service provider” is meant a group or individual who provides a service, the cost of which may be partially or fully covered by insurance.

By “electronically transmissible” is meant that information or data can be wirelessly transmitted from one device to another. The term “electronically transmissible” is meant to include both short range (e.g., by Bluetooth®) and long range (e.g., by cellular network or wireless local area network) transmission of information.

### BRIEF DESCRIPTION OF THE DRAWINGS

FIG. 1 is a block diagram illustrating the organizational components of a communication system in accordance with the invention.

FIG. 2 is a block diagram illustrating an application of the system in instances in which a medical provider or pharmacy requires the insured's insurance information to validate coverage, eligibility, claim information, or verify appropriate identification.

FIG. 3 is a block diagram illustrating the insured's ability to receive insurance information changes via text message made by his employer or his own decision.

FIG. 4 is a block diagram illustrating an insurance company making a sale and transmitting a new company's medical, dental, prescription drug, or vision coverage, the information is entered into the insurance company's computer network and systems via the administration department.

FIG. 5 is an illustration of a typical insurance card display on the insured's cellular phone/PDA.

FIG. 6 is an illustration of an alternate display of insurance card information which omits graphics associated with the insurance card.

FIG. 7 is an illustration of a display of a typical insurance company communication which proactively targets the insured through the use of text messaging as a result of the insurance company having the insured's cell phone number.

FIG. 8 is an illustration of a display of a further insurance company communication regarding the insured's health.

FIG. 9 is a block diagram illustrating an insurance company's receipt of the contact phone numbers of all insured members in a new company group.

FIG. 10 is a block diagram illustrating typical data that is transferred between the insurance company and the insured.

### DETAILED DESCRIPTION OF THE INVENTION

The present invention relates to devices and methods for providing insurance information to a mobile communication device (e.g., a cell phone or personal data assistant) of an individual (e.g., an insured or an insured family member). It is to be understood that the following description provides a basis or foundation of different embodiments or examples without departing from the spirit of the invention. Specific examples of components and arrangements are described below in an exemplary manner only.

The invention includes a system for sending and receiving insurance information between an insurance company and an insured individual's mobile communication device. In one aspect, the invention features a method providing insurance that requires the insured's cell phone number or permission to access the insured's mobile communication device. This method can include mandatory disclosure of the insured's cell phone number and/or email address as well as voluntary submission by the individual in order to participate in the system with personal mobile communication device.

### Insurance Information

The invention features the transmission of insurance data from an insurance provider to the mobile communication device of an insured individual. The insurance information (data) can include:
i. Medical insurance data, including but not limited to:
   1. insurance company name and logo;
   2. network name and logo;
   3. employer name and logo;
   4. group identification number;
   5. insurance company toll-free phone number for member services, or any other number typically included on specific company's ID card;
   6. insured's name;
   7. copayment amounts, such as emergency room, doctor visits, etc.;
   8. deductible and/or coinsurance amounts;
   9. insurance company website; and
   10. other associated labeling typically included with insurance company ID card.
ii. Dental insurance data, including but not limited to:
   1. insurance company name and logo;
   2. network name and logo;
   3. employer name and logo;
   4. group identification number;
   5. insurance company toll-free phone number for member services, or any other number typically included on specific company's ID card;
   6. insured's name;
   7. copayment amounts, if applicable to specific dental program;
   8. deductible and/or coinsurance amounts;
   9. insurance company website; and
   10. other associated labeling typically included with insurance company ID card.
iii. Vision insurance data, including but not limited to:
   1. insurance company name and logo;
   2. network name and logo;
   3. employer name and logo;
   4. group identification number;
   5. insurance company toll-free phone number for member services, or any other number typically included on specific company's ID card;
   6. insured's name;
   7. copayment amounts, if applicable to specific vision program;
   8. insurance company website; and
   9. other associated labeling typically included with insurance company ID card.
iv. Life/disability insurance data, including but not limited to:
   1. insurance company name and logo;
   2. employer name and logo;
   3. group identification number;
   4. insurance company toll-free phone number for member services, or claim intake;
   5. insured's name;
   6. disability plan description, coverage details; and
   7. insurance company website.

### Medical Information

The invention also features the transmission of medical information from an insurance provider to the mobile communications device of an individual. For example, if the insured fills a script for a brand name drug which has a generic alternative, the insurance company may message the insured via technology encouraging the use of generic medication. In another example, if the insured fills a maintenance medication script at a retail pharmacy, the insurance company may message the insured via technology encouraging the use of a mail order pharmacy, including hyperlink and/or phone number for mail order access. In other examples, the insurance company may message the insured (i) to remind them to fill a script; (ii) to alert them to pharmacy programs, e.g. specialty pharmacy and switching to a generic alternative; (iii) relative to approval or denial of prescription drug authorizations; or (iv) regarding step therapy programs included in benefit plan. The transmission of electronic information may be two-way. For example, the insurance company may message the insured reminding them to refill a prescription, and insured replies that they are allergic to original drug and will try an alternative prescribed by physician. In another example, the insurance company may suggest a generic alternative to a prescribed drug, and the insured replies that the physician specifically requested the brand name drug for a specific reason.

In addition the system may be employed to send messages and/or encrypted messages regarding clinical or health management programs and/or recommendations such as:
i. stop a therapy;
ii. wellness reminders, such as reminder to obtain a mammogram or prostate exam;
iii. initiation of medical record transfer
iv. disease management programs—asthma, diabetes, coronary artery disease, congestive heart failure, and any other disease state included in insurance company programs;
v. maternity management programs;
vi. case management programs;
vii. patient management programs;
viii. health coaching;
ix. transplant management programs; and
x. emergency messaging.

### Mobile Communication Devices

The invention features transmission of insurance and medical information to mobile communication devices. Mobile communication devices connect remotely to data providers over, e.g., cellular phone networks or wireless internet routers. When transmitted over cellular phone networks or wireless internet routers, information of the invention can be transmitted, e.g., as an Application 2 Mobile—Short Messaging Service (SMS) text message, email, or over the world wide web.

Mobile communication devices include cell phones, personal data assistants (PDAs), and so called smart phones (e.g., devices running Google's® Android® operating system or a Microsoft Windows® operating system or be an Apple® device, such as an iPhone).

### EXAMPLES

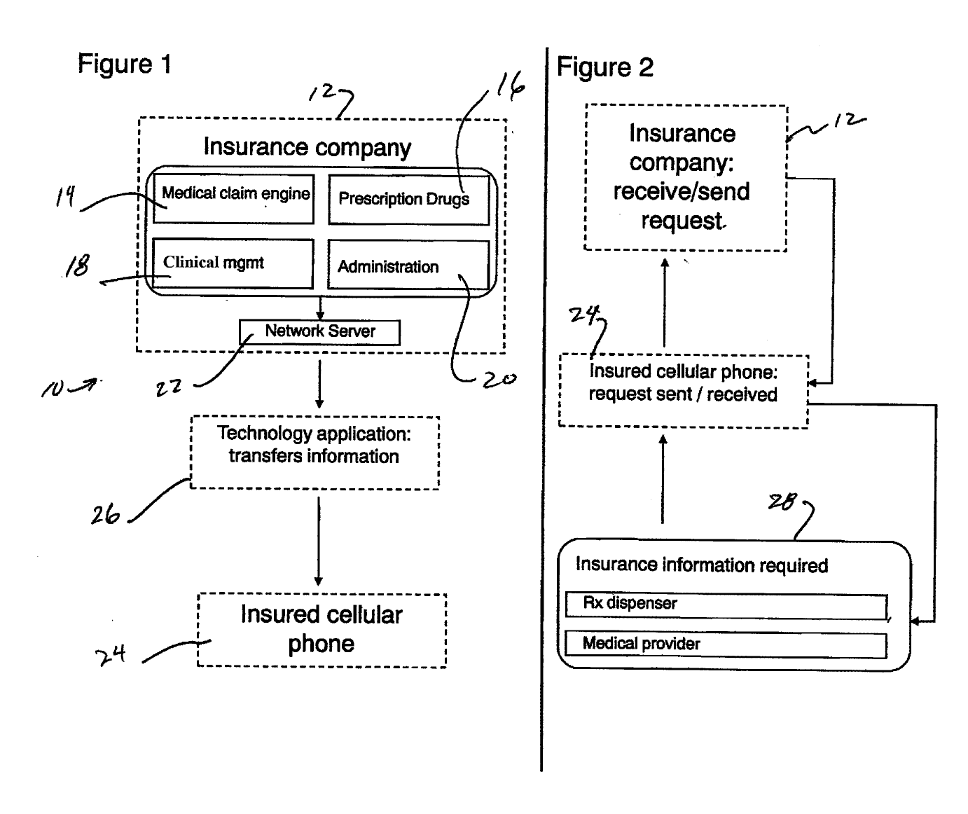

FIG. 1 is a block diagram illustrating the organizational components of a communication system 10 in accordance with the invention. The term “insurance company” can describe medical insurance, dental insurance, life/disability, vision, and other types of insurance companies. Within the insurance company 12 lies its medical claim engine 14 (system) which incorporates proprietary clinical algorithms to calculate healthcare cost and healthcare management in relation to individuals and group populations based on demographics, age, sex, location, individual claim history, and size to name a few. The medical claim engine 14 has the ability to assess and stratify the risk of the insurance company's insured population, as well as complete ongoing reassessments. Prescription drug data 16 is integrated into the same claim 14 to assist with the prediction of potential adverse health events for an individual and/or group population. These adverse events are then targeted in a variety of ways to improve individual health status, and thereby reduce overall cost/spend. Clinical management teams (i.e. disease management, patient safety, case management, patient management, etc.) programs 18 seek to work with the insured population that has been identified as eligible for participation in the clinical management program. These programs include, but are not limited to, asthma, depression, diabetes, heart disease, obesity, back pain, pulmonary disease, and other related and unrelated, targeted conditions. The administration division 20 comprises all aspects of servicing the group insurance plans. The insurance company's numerous computer and network systems relate to all associated technology needs within the insurance organization.

The system assures the secure transference of an insured's insurance information from the insurance company's computer network server 22 to the insured's cellular phone/PDA 24. The transfer requires the insured's cellular phone number (which is submitted to the insurance company with the completion of the insured company's sale of insurance), an insurance company's phone number for sending and receiving information, and a third party technology application 26, e.g. cellular network, text messaging, SMS, PDA wireless network, etc.

The third party technology application 26 provides “send-to-mobile” data delivery capabilities from the insurance company to the insurance member's mobile phone/PDA. “Send to Mobile”, also commonly referred to as “Application 2 Mobile—Short Messaging Service (SMS) domain” or “Application to Person (A2)”, allows the insurance company to send (or “blast”) the insurance information (including, but not limited to, insurance identification information, prescription drug information, etc) and logos directly to the insured member and dependents, utilizing the cellular phone number as the directional method of delivery. The insured member is then able to view the insurance identification information on his/her cellular phone/PDA, thereby eliminating the need to carry a physical insurance identification card in his/her wallet/purse.

The insured is assumed to have a cellular phone number at the time of the insurance sale. The insurance company's phone number will be the same for a large group (if not all) of its insured population, and this number will be communicated to the insured at the time of the insurance sale. The transference of information from the insurance company through the third party technology application 26 to the insured (and vice versa) is real time. Therefore, the insured has the ability to obtain, access, provide, or transfer his or her insurance information twenty-four hours per day, seven days per week.

Once the contact and messaging is established, the insurance company has the ability to communicate and send ongoing changes to coverage and update information as it relates to these changes, including state mandated plan changes and employer driven plan changes.

FIG. 2 is a block diagram illustrating an application of the system in instances wherein a medical provider or pharmacy requires the insured's insurance information 28 to validate coverage, eligibility, claim information, or verify appropriate identification. As a result of this need from the medical provider or pharmacy, the insured has the ability, using his cellular phone/PDA, to obtain the requested insurance information in real time. The insured's request is made and transferred via the third party technology application directly to a pre-determined phone number. The request is immediately relayed to the insurance company's computer network/system or insurance company data vendor, and the insurance company's information is conveyed to the insured's cellular phone/PDA, thereby reducing lag time. The insured, with the requested insurance information sent to his cellular phone/PDA, now has the ability to have services rendered at the medical provider or pharmacy.

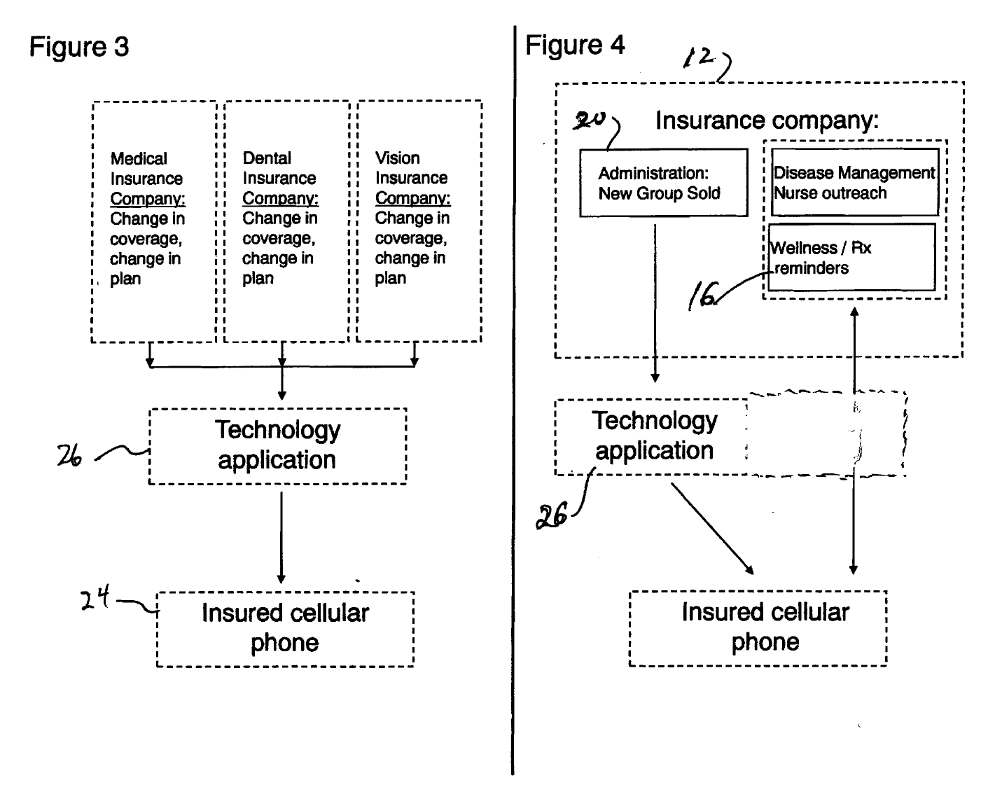

FIG. 3 is a block diagram illustrating the insured's ability to receive insurance information changes via text message made by his employer or his own decision. The insured has the ability to receive real time insurance information changes, via text messages, for medical, prescription drug, life/disability, vision, and dental insurance to name a few. The ability to receive real time information reduces the lag associated with insurance services rendered. Also, the insured has the ability to receive new insurance information with a new insurance company with the receipt of the new insurance company phone number. The change in insurance companies and/or plans allows the insured to have services rendered immediately and to receive the information immediately.

With reference to FIG. 4, when an insurance company 12 makes a sale and insures a new company's medical, dental, prescription drug, or vision coverage, the information is entered into the insurance company's computer network and systems via the administration department 20.

A crucial piece of new data that is entered into the insurance company's computer system is the insured's cellular phone number. This phone number allows for the transfer, via the third party's technology application 26, of insurance information from the insurance company to the insured. The phone number also provides the insurance company with the opportunity to message and contact the insured via the insured's cellular phone/PDA.

The disease management division in the insurance company has the insured's cellular phone number and can make outreach text messaging or telephone calls to the insured based on the medical claim engine's results. For example, an insured may be eligible for an asthma-based disease management program, but was unaware of this eligibility. The insurance company's disease management professionals have the ability to contact the insured, and assist the insured with his condition/disease and help the insured improve their health.

The wellness/prescription drug database enables the insurance company to contact the insured for other insurance related offers and services which include, but are not limited to, safety alerts (i.e. drug to drug contraindications, drug to disease contraindications, delete a therapy, add a therapy, etc.) wellness reminders, prescription drug refills, prescription drug authorizations, generic alternative availability messages, step therapy guidance, health and wellness coaching, biometric screening locations, health tools, lifestyle management, personal health solutions, and emergency messaging.

The insurance company thus has the ability through direct one on one real time messaging to help its insured population take control of potential and actual high risk health conditions and prevent higher risk and higher cost status. Ultimately, the insured's phone number allows the insurance company a solution to solving problems such as gaps in care, consumer engagement, behavior change, coaching support, and disease management engagement and enrollment.

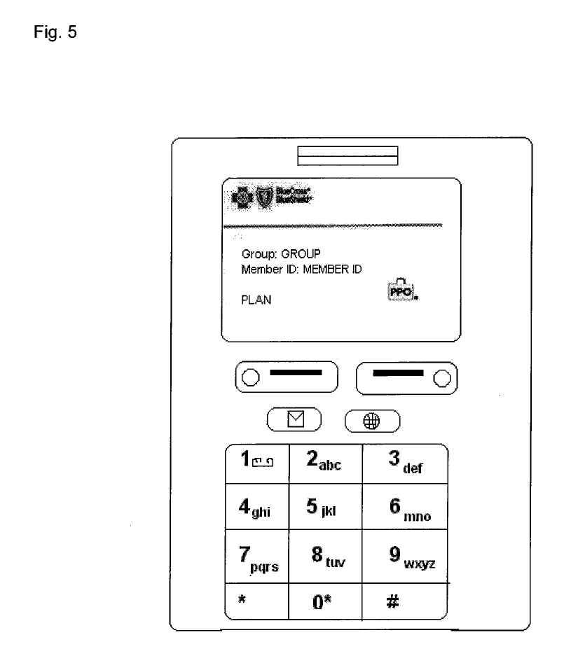

FIG. 5 illustrates a typical insurance card display on the insured's cellular phone/PDA. When an insurance company provides coverage for a new company, it creates a new group profile by issuing the new group an identification number, known as the group number, and incorporates aspects of the plan design to create medical identification cards. The insurance identification card normally displays the insured's name, unique identification number, copayment amounts such as emergency room and doctor's visits, insurance company logo, insurance company website, customer service phone numbers, prescription drug phone numbers, medical network indicator and associated labeling with the particular insurance plan. The back of a typical plastic card also contains information required by law in certain states, which can be added below the image of the front of a typical card, specifically by utilization of the scroll function on a cellular phone/PDA.

This information can be displayed on the insured's cellular phone/PDA, having been transferred by the insurance company to the insured through the third party technology application. This information can be sent to the insured by texting to a predetermined number that generates the information in real-time to the insured's cellular phone/PDA. The information can be used in medical provider offices or hospitals, for example, as well as pharmacies.

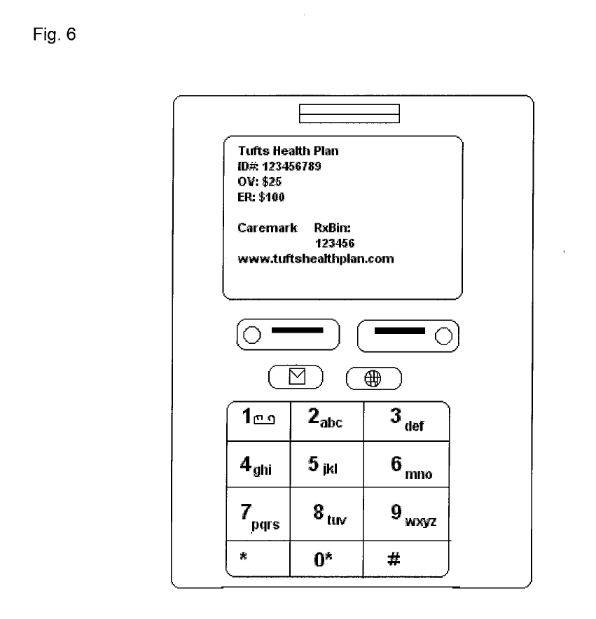

FIG. 6 illustrates an alternate display of insurance card information which omits graphics associated with the insurance card. The figure depicts the insurance information described in FIG. 5 sent to an insured's cellular phone that, e.g., does not have the capabilities to receive images. Because not all cellular phones/PDA have graphic capabilities, the system and method acknowledge this fact and have the capability to provide the necessary information for the insured. The vital information is included in the insured's cellular display and therefore the insured is able to provide the data to the appropriate physician office, hospital, or pharmacy.

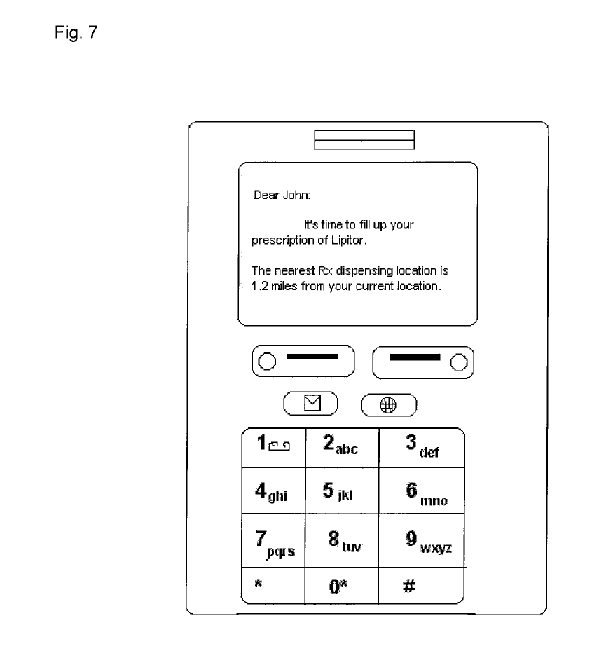

FIG. 7 illustrates a display of a typical insurance company communication which proactively targets the insured through the use of text messaging as a result of the insurance company having the insured's phone number. Voice messaging is also encompassed in the invention. The insurance company's messaging can include, but is not limited to, generic prescription usage or fill recommendations, disease management participation or eligibility based on the insurance company's claim data engine, and medical provider/hospital/pharmacy locations. Insurance company prescription drug recommendations could include step therapy or alternative generic substitution to the insured. It could also include safety alerts, such as drug to drug interactions, drug to disease, and other aforementioned safety information. The messaging capabilities between the insurance company and the insured via text messaging allow real time decision-making and services rendered.

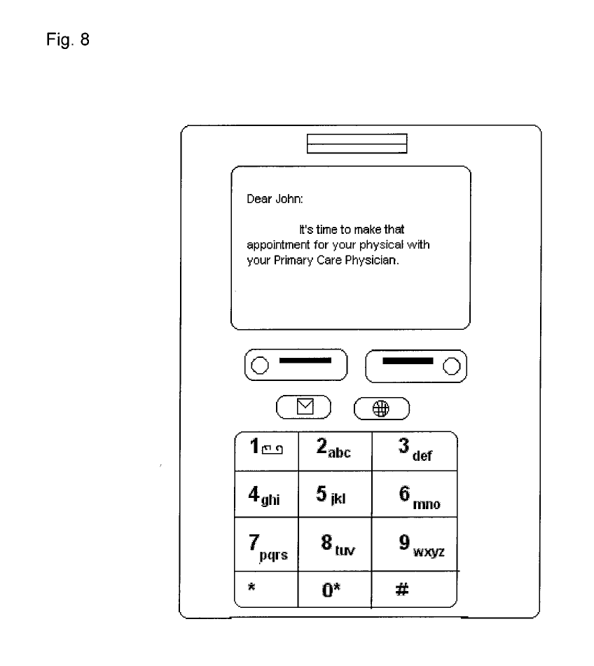

FIG. 8 illustrates a display of a further insurance company communication regarding the insured's health. For example, the insurance company can remind the insured to see the primary care physician. The insurance company could also remind an employee that they are due for a mammogram or prostate exam (for example) but claim records show he has not received one. The insurance company has the ability to promote healthy lifestyle tips, wellness promotions, and other healthy strategies for the insured's health management. The insurance company's ability to communicate healthy behaviors enables the insured to proactively manage his or her own health.

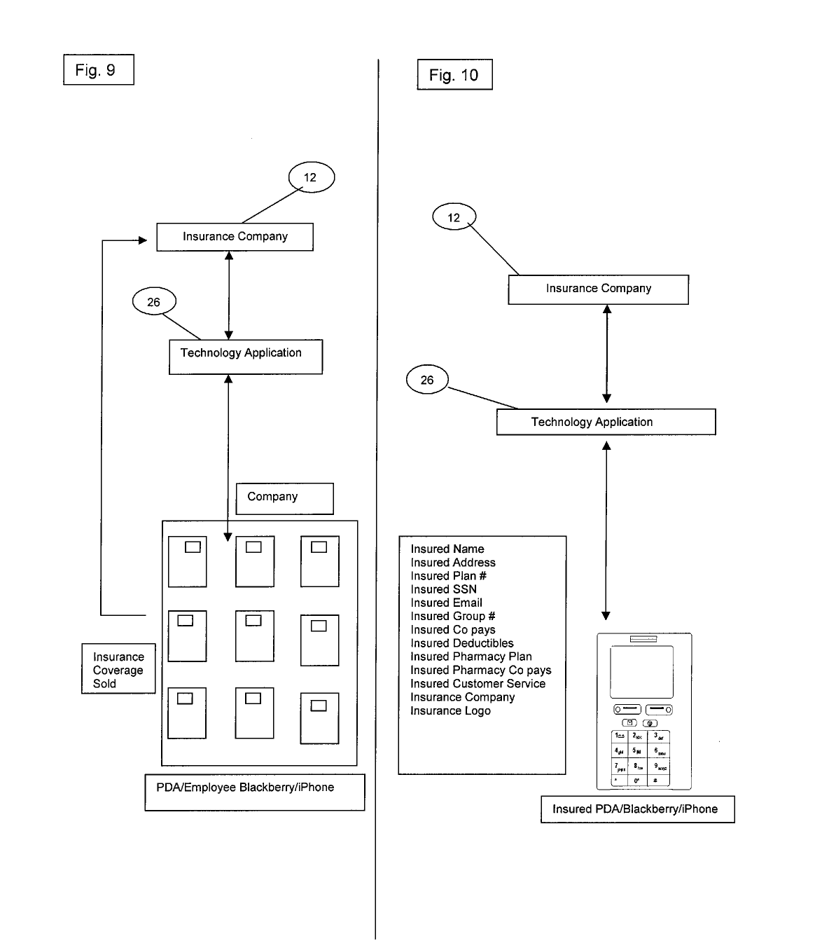

FIG. 9 is a block diagram illustrating an insurance company's receipt of the contact phone numbers of all insured members in a new company group. When an insurance company sells its insurance services to a company, the insurance company pledges its services to the group of insured members and their spouses and dependents. Upon confirmation of the sale, the insurance company receives each insured, spouse, and, when applicable, dependent cellular phone/PDA phone number. The method of receipt could include a file transfer, or paper forms, or any other method deemed acceptable by the insurance company. Utilizing the third party technology application, the insurance company then has the opportunity to message individual insured members through their cellular phone/PDA and insured members can request real time insurance information using their cellular phone/PDA.

FIG. 10 is a block diagram illustrating typical data that is transferred between the insurance company and the insured. This data is encoded on a data file for submission for each individual insured among the group.

In accordance with the invention the insurance company can utilize collected cell phone/PDA numbers to message insured relative to disease specific and/or other health management programs to encourage access to required preventive services, such as annual physical, to ask for participation in programs outside the scope of the current product offering such as special offers, pilot programs for potential future product development and other potential new offerings from the insurance company.

Additionally, the system provides a venue for exchange of information from employer to insured through the insurance company. Typical communications of this nature include, but are not limited to:
i. employer offering incentives for participation in a health program;
ii. employer is offering a health fair (i.e. blood pressure screening, etc.) at their on-site location; and
iii. employer is offering on-site testing and clinics in its in-house medical/nursing facility.

The insurance company can also provide the insured's cellular phone/PDA number to the insured's primary care physician or facility for appointment scheduling or contact abilities.

Additionally, the insured or insured's dependent's healthcare provider, such as doctor or hospital, can immediately contact other related insured members in the case of an emergency for instant contact.

The insured also has the ability to receive from the insurance company, information via cellular phone/PDA regarding the quality of the provider, as well as the information regarding specific cost of medical services as well as the medical services and outcome data. This information will assist the insured with making informed medical decisions.
The system also provides the ability and functionality for insured patients to make appointments with providers in real time.

The system also provides the insurance company with an entirely new line of communication with its insured population, including the ability to target and communicate with:

Targeted insured employers based on:
i. location;
ii. size;
iii. industry; and
iv. workforce composition/demographic.

Targeted insured members based on:
i. age;
i. sex;
ii. gender;
iii. location; and
iv. company size.

Under the system of the invention, the insurance company's administrative and operational burdens and costs associated with producing and sending paper identification cards, using envelopes and postage are reduced.

Further, the invention provides for the insurance company's reduction of healthcare claim costs associated with the inability to contact its population for disease management and other programs regarding the health of the population, group, and insured. Health populations lower the risk to the insurance company, which lowers the healthcare costs for the insurance company.

### OTHER EMBODIMENTS

Various modifications and variations of the described methods and compositions of the invention will be apparent to those skilled in the art without departing from the scope and spirit of the invention. Although the invention has been described in connection with specific desired embodiments, it should be understood that the invention as claimed should not be unduly limited to such specific embodiments. Indeed, various modifications of the described modes for carrying out the invention that are obvious to those skilled in the fields of insurance or related fields are intended to be within the scope of the invention.

All publications mentioned in this specification are herein incorporated by reference to the same extent as if each independent publication was specifically and individually incorporated by reference.

What is claimed is:

1. A mobile communication device, wherein said device stores an individual's insurance information, wherein said information is viewable on said device, and wherein said information is sufficient to allow a service provider to identify the source and content of said individual's insurance coverage using a service provider computer.

2. The mobile communication device of claim 1, wherein said insurance information comprises said individual's insurance account number or identification number assigned by the insurance provider or insured's employer and the name of the individual's insurance provider.

3. The mobile communication device of claim 2, wherein said insurance information further comprises at least one of the following: the insurance provider's logo, the insurance provider's network name, the insurance provider's network logo, the individual's employer's name, the individual's employer's logo, the individual's group identification number, the insurance provider's telephone number, the individual's name, the individual's copayment, the individual's deductible, and the insurance provider's web address.

4. The mobile communication device of claim 1, wherein said information is electronically transmissible to said service provider computer.

5. The mobile communication device of claim 4, wherein the electronically transmissible information can be transmitted wirelessly.

6. The mobile communication device of claim 1, wherein said insurance is selected from the group consisting of medical insurance, dental insurance, vision insurance, and life insurance.

7. The mobile communication device of claim 1, wherein said insurance is medical insurance and said service provider is a medical service provider.

8. The mobile communication device of claim 7, wherein said mobile communication device further stores medical information and said medical information is viewable on said device.

9. The mobile communication device of claim 8, wherein said medical information is selected from the group consisting of: a reminder to take at least one medication, identification of a generic alternative to a brand name drug, information regarding a mail order pharmacy, a reminder to fill a prescription, information regarding denial or approval of prescription drug authorizations, and information regarding a step therapy program.

10. The mobile communication device of claim 8, wherein said medical information is selected from the group consisting of: information regarding drug to drug interaction, information regarding drug to disease interactions, information regarding adding a therapy, information regarding stopping a therapy, information regarding wellness reminders, information regarding the initiation of a medical records transfer, information regarding disease management, information regarding maternity management, information regarding case management, information regarding patient management, information regarding health coaching, information regarding transplant management, and emergency messaging.

11. A method of providing an individual with insurance information, said method comprising transmitting said insurance information to said individual's mobile communication device.

12. The method of claim 11, wherein said information comprises said individual's insurance account number and the name of said individual's insurance provider.

13. The method of claim 12, wherein said information also comprises at least one of the following: the insurance provider's logo, the insurance provider's network name, the insurance provider's network logo, the individual's employer's name, the individual's employer's logo, the individual's group identification number, the insurance provider's telephone number, the individual's name, the individual's copayment, the individual's deductible, and the insurance provider's web address.

14. The method of claim 11, wherein said insurance is selected from the group consisting of medical insurance, dental insurance, vision insurance, and life insurance.

15. The method of claim 11, wherein said insurance is medical insurance.

16. The method of claim 15, wherein said method further comprises transmitting medical information.

17. The method of claim 16, wherein said medical information is selected from the group consisting of: a reminder to take at least one medication, identification of a generic alternative to a brand name drug, information regarding a mail order pharmacy, a reminder to fill a prescription, information regarding denial or approval of prescription drug authorizations, and information regarding a step therapy program.

18. The method of claim 16, wherein said additional medical information is selected from the group consisting of: information regarding drug to drug interaction, information regarding drug to disease interactions, information regarding adding a therapy, information regarding stopping a therapy, information regarding wellness reminders, information regarding the initiation of a medical records transfer, information regarding disease management, information regarding maternity management, information regarding case management, information regarding patient management, information regarding health coaching, information regarding transplant management, and emergency messaging.

19. The method of claim 11, wherein said information is transmitted by email, SMS text message, or through the world wide web.

20. The method of claim 16, wherein said medical information is imported into the calendar of said mobile communication device.
